(19) United States
(12) Patent Application Publication
(10) Pub. No.: US 2023/0286506 A1
(43) Pub. Date: Sep. 14, 2023

(54) GEAR SHIFT ACTUATION SIMPLIFICATION

(71) Applicant: Eaton Cummins Automated Transmission Technologies, LLC, Galesburg, MI (US)

(72) Inventor: Graeme Andrew Jackson, Kalamazoo, MI (US)

(21) Appl. No.: 18/131,937

(22) Filed: Apr. 7, 2023

Related U.S. Application Data
(63) Continuation-in-part of application No. 17/159,256, filed on Jan. 27, 2021, now Pat. No. 11,673,552.
Application No. 17/159,256 is a continuation of application No. 15/663,168, filed on Jul. 28, 2017, now Pat. No. 10,906,546.
(60) Provisional application No. 63/328,925, filed on Apr. 8, 2022.
(60) Provisional application No. 62/438,201, filed on Dec. 22, 2016.
(60) Provisional application No. 62/465,021, filed on Feb. 28, 2017.
(60) Provisional application No. 62/465,024, filed on Feb. 28, 2017.

(51) Int. Cl. B60W 30/18; F16H 37/04; B60K 17/28; B60W 10/02; B60W 10/06; B60W 10/111; B60W 10/115; B60W 10/196; B60W 30/188; B60W 30/19; B60W 40/13; B60W 50/02; B60W 50/035; F16D 25/04; F16D 48/02; F16D 48/06; F16H 3/091; F16H 3/093; F16H 57/00; F16H 61/02; F16H 61/04; F16H 3/64; F16H 57/02; F16H 59/02; F16H 61/06; F16H 61/08; H04B 10/077; H04J 3/12; B60W 10/11; B60W 50/00; F16D 25/12; F16H 61/00

(52) U.S. Cl. CPC B60W 30/18027; B60K 17/28; B60W 10/02; B60W 10/06; B60W 10/11; B60W 10/111; B60W 10/115; B60W 10/196; B60W 30/19; B60W 30/188; B60W 40/13; B60W 50/00; B60W 50/035; B60W 50/0205; F16D 25/04; F16D 25/14; F16D 25/126; F16D 48/066; F16H 3/64; F16H 3/091; F16H 3/093; F16H 37/043; F16H 37/046; F16H 57/0006; F16H 57/02004; F16H 59/0204; F16H 61/06; F16H 61/08; F16H 61/0021; F16H 61/0213; F16H 61/0403; H04B 10/0775; H04J 3/125; F16D 2500/30808; F16H 61/04; F16H 2063/005

(57) ABSTRACT

A transmission is subject to gear shift management that provides for shifting gears in a controlled manner in order to provide for a simplification of part and reduction in system complexity. In particular, a range synchronizer component can be replaced with a simplified range jaw clutch, without incurring a requirement for an installation of other components such as a motor generator or starter-generator.

### CROSS REFERENCE TO RELATED APPLICATIONS

This application claims priority to and the benefit of the following U.S. Provisional Pat. Application: Serial No. 63/328,925 (Attorney Docket No. 79891-011US300), filed Apr. 8, 2022, entitled “GEAR SHIFT ACTUATION SIMPLIFICATION.” This application is also continuation-in-part of, and claims the benefit of priority of, U.S. Non-Provisional Pat. Application Serial No. 17/159,256 (Attorney Docket No. 79891-003US401), filed Jan. 27, 2021, entitled “HIGH EFFICIENCY, HIGH OUTPUT TRANSMISSION”; which claims priority to U.S. Non-Provisional Pat. Application Serial No. 15/663,168 (Attorney Docket No. 79891-003US100), filed Jul. 28, 2017, entitled “HIGH EFFICIENCY, HIGH OUTPUT TRANSMISSION”; which claims priority to the following U.S. Provisional Pat. Applications: Serial No. 62/438,201 (Attorney Docket No. EATN-1100-P01), filed Dec. 22, 2016, entitled “HIGH EFFICIENCY, HIGH OUTPUT TRANSMISSION”; Serial No. 62/465,021 (Attorney Docket No. EATN-1123-P01), filed Feb. 28, 2017, entitled “SYSTEM, METHOD, AND APPARATUS FOR CONTROLLING A HIGH OUTPUT, HIGH EFFICIENCY TRANSMISSION”; and Serial No. 62/465,024 (Attorney Docket No. EATN-1130-P01), filed Feb. 28, 2017, entitled “UTILIZATION OF A SHAFT DISPLACEMENT ANGLE IN A HIGH EFFICIENCY, HIGH OUTPUT TRANSMISSION”. All of the applications listed above are hereby incorporated by reference in their entirety.

### BACKGROUND

Transmissions serve a critical function in translating power provided by a prime mover to a final load. The transmission serves to provide speed ratio changing between the prime mover output (e.g. a rotating shaft) and a load driving input (e.g. a rotating shaft coupled to wheels, a pump, or other device responsive to the driving shaft). The ability to provide selectable speed ratios allows the transmission to amplify torque, keep the prime mover and load speeds within ranges desired for those devices, and to selectively disconnect the prime mover from the load at certain operating conditions. Clever and often complicated apparatus (and the following manners of operation of such apparatus) have been a focus of much inventive effort.

Transmissions are subjected to a number of conflicting constraints and operating requirements. For example, the transmission must be able to provide the desired range of torque multiplication while still handling the input torque requirements of the system. Additionally, from the view of the overall system, the transmission represents an overhead device – the space occupied by the transmission, the weight, and interface requirements of the transmission are all overhead aspects to the designer of the system. Transmission systems are highly complex, and they take a long time to design, integrate, and test; accordingly, the transmission is also often required to meet the expectations of the system integrator relative to previous or historical transmissions. For example, a reduction of the space occupied by a transmission may be desirable in the long run, but for a given system design it may be more desirable that an occupied space be identical to a previous generation transmission, or as close as possible. Conversely, a focus on physical items may dictate modes and manner of operation.

Previously known transmission systems suffer from one or more drawbacks within a system as described following. Previously known gear sets have relatively few design degrees of freedom, meaning that any shortcomings in the design need to be taken up in the surrounding transmission elements. For example, thrust loads through the transmission, noise generated by gears, and installation issues such as complex gear timing issues, require a robust and potentially overdesigned system in the housing, bearings, and/or installation procedures. Previously known high output transmissions, such as for trucks, typically include multiple interfaces to the surrounding system (e.g., electrical, air, hydraulic, and/or coolant), each one requiring expense of design and integration, and each introducing a failure point into the system.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, the subject disclosure pertains to shift management of a vehicle transmission. It is to be appreciated that shift management may be enacted through a control device, and that a control device may be local to an operating transmission or remote from an operating transmission. Through an innovative approach to shift management, component complexity can be mitigated, thereby inducing benefits along the spectrum of vehicle operations, from tradeoffs in design, to reducing part costs and enabling manufacturing simplifications, to optimizing fleet maintenance.

It is to be appreciated that in addition to system complexity, multiple trade-off considerations, and a competitive environment, factors in the trucking industry such as fuel costs, driver availability, ecological concerns and governmental regulations make it so that there remains a need for improvements in the design of high output transmissions, particularly truck transmissions, and improved methods of operation thereof.

Applicants have thus devised improved methods of operational control, which of themselves provide for an ability to reduce structural configuration and thus obtain benefits to improved system lowered complexity, while mitigating adverse trade-offs or requirement of additional components as may be common, and thus provide improvements not limited to front end manufacturing costs, but also may include alleviating component maintenance concerns, and improving overall fleet management.

According to one aspect, a system is provided comprising a processor coupled to a memory that includes instructions that, when executed by the processor, cause the processor to engage in a controlled manner through the shift management. The instructions can further cause the processor to provide an alternative embodiment of a shift management sequence, whereby benefits such as smooth and fast gear engagements may be obtained.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

The patent or application file contains at least one drawing executed in color, as drawings may be necessary as the only practical medium by which to disclose the subject matter sought to be patented in a utility patent application as discussed in 37 C.F.R. §1.84(a)(2). Copies of this patent or patent application publication with color drawing(s) will be provided by the Office upon request and payment of the necessary fee.

FIG. 1 illustrates a transmission cutaway view highlighting particular portions that will be discussed in later aspects of the innovation.

FIG. 2 is a transmission schematic related to FIG. 1

FIG. 3 is a transmission schematic highlighting particular portions that will be discussed in later aspects of the innovation.

FIG. 4 is a control state diagram of an example shift sequence.

FIG. 5 is a control state diagram of an example shift sequence highlighting aspects of the innovation.

FIGS. 6A-B are flow chart diagrams of example methods of shift management according to aspects of the innovation.

FIG. 7 is a combination flow chart diagram and control state diagram and example speed versus normalized time chart of the method shown in FIGS. 6.

FIG. 8 is an example schematic indicating components within a range group that may be eliminated based on aspects of the innovation.

FIG. 9 is a block diagram illustrating a suitable operating environment for aspects of the subject disclosure.

### DETAILED DESCRIPTION

Without limitation to a particular field of technology, the present disclosure is directed to improvements of transmissions configured for coupling to a prime mover, and more particularly to transmissions for vehicle applications, including truck applications. Even more particularly, the present disclosure is directed to improved processing of gear shift operations that provide for reductions in parts, reductions in related front end costs, improved operations, and incumbent savings from operations including maintenance.

It is to be appreciated that an example transmission includes an input shaft configured to couple to a prime mover, a countershaft having a first number of gears mounted thereon, a main shaft having a second number of gears mounted thereon, a shifting actuator that selectively couples the input shaft to the main shaft by rotatably coupling at least one of the first number of gears to the countershaft and/or coupling the second number of gears to the main shaft, where the shifting actuator may be mounted on an exterior wall of a housing, and where the countershaft and the main shaft may be at least partially positioned within the housing.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

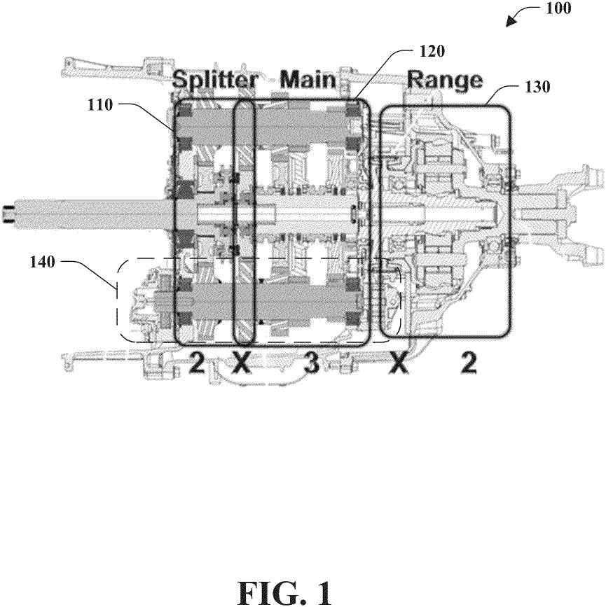

Turning to FIG. 1, a transmission 100 is illustrated in a cutaway view highlighting particular portions or groups upon which component simplification can occur in accordance with the subject disclosure. It is to be appreciated that a set of co-owned innovations, for example as presented in patent applications including 16/596,429; 15/663,201; 62/438,201; 62/465,021; and 62/465,024; as well as Patent Cooperation Treaty applications PCT/US2017/044491; PCT/US2017/044514; PCT/US2017/044518; PCT/US2017/044524; and PCT/US2017/044531, provide an example physical setting in which the present innovation may be more easily grasped. For sake of clarity of discussion, a transmission 100 may be viewed as consisting of a splitter group 110, main group 120 and a range group 130. Operation of the transmission often involves power transfer from a countershaft group 140, as known in existing transmission systems. The designation of 2 × 3 × 2, as well as certain figure acronyms, are also known in existing transmission systems, and for sake of clarity are not discussed herein. It is contemplated and to be appreciated that yet other such architectures commonly known in the industry, e.g., 2×4×2, 3×3×2, can apply the features, functions of benefits of the innovation as disclosed and claimed herein. These alternative embodiments are to be included within the spirit and scope of this disclosure and claims appended hereto.

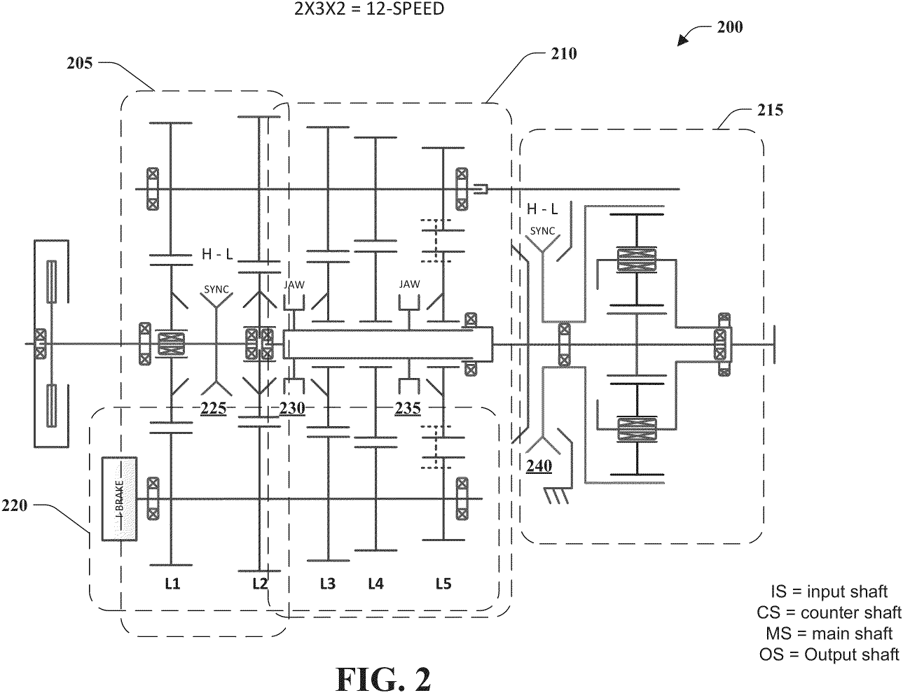

Turning to FIG. 2, a transmission schematic 200 is illustrated upon which component simplification can occur in accordance with the subject disclosure. Transmission schematic 200 is related to FIG. 1 and is depicted in engineering block form, in which splitter group 205 (including splitter synchronizer 225), main group 210 (including main jaw clutch 230 and second main jaw clutch 235), range group 215 (including range synchronizer 240), and countershaft group 220, are reflective of the similar numbered items of FIG. 1.

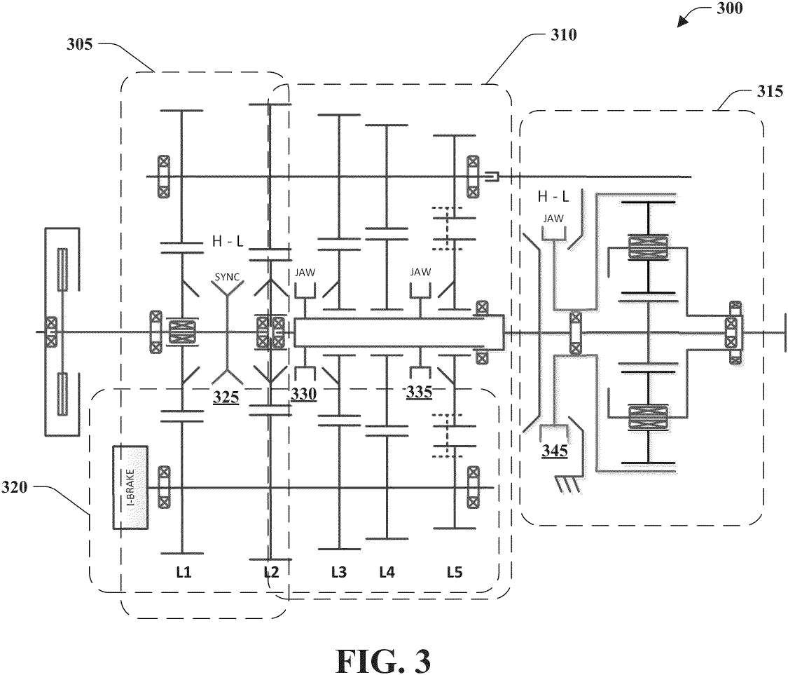

In contrast to FIG. 2, FIG. 3 illustrates a transmission schematic 300 highlighting similar portions of a transmission that portrays an innovative improvement in physical structure as may result from the application of aspects of the innovation disclosed herein. Similar, although with differences as noted, the transmission schematic 300 includes a splitter group 305 (including splitter synchronizer 325), main group 310 (including main jaw clutch 330 and second main jaw clutch 335), range group 315 (including range jaw clutch 345), and countershaft group 320. As illustrated, the range group 315 is able to utilize a range jaw clutch 345 without the introduction of other components. This is in contrast to the range group 215 as shown in FIG. 2, in which a range synchronizer 240 component is provided (e.g., with a different shift management sequence as disclosed).

This is also in contrast to previously known transmission systems in which a splitter jaw clutch has been used to simplify components of a different group in a transmission, that of a splitter synchronizer, removing a splitter synchronizer ring. As known in such existing transmission systems, the range group of that transmission has not one but two synchronizer rings, as well as the simplification for the exchange of a splitter jaw clutch for a splitter synchronizer in the splitter group being achieved with the addition of a separate component (e.g., actuating unit 11, including a starter-generator or motor generator module). In accordance with aspects of the subject disclosure, no such additional components (and resultant complexities, part costs, and maintenance concerns) are necessary.

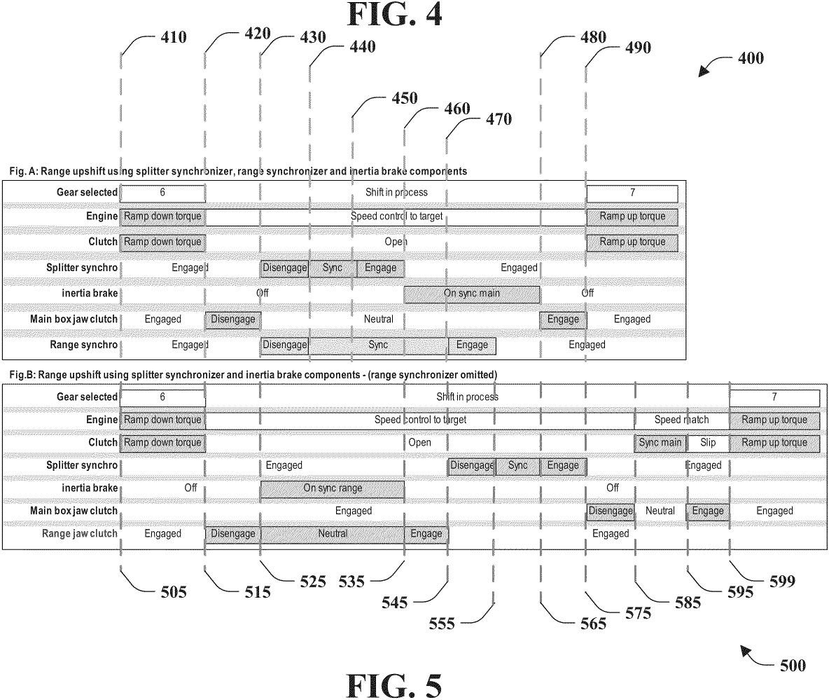

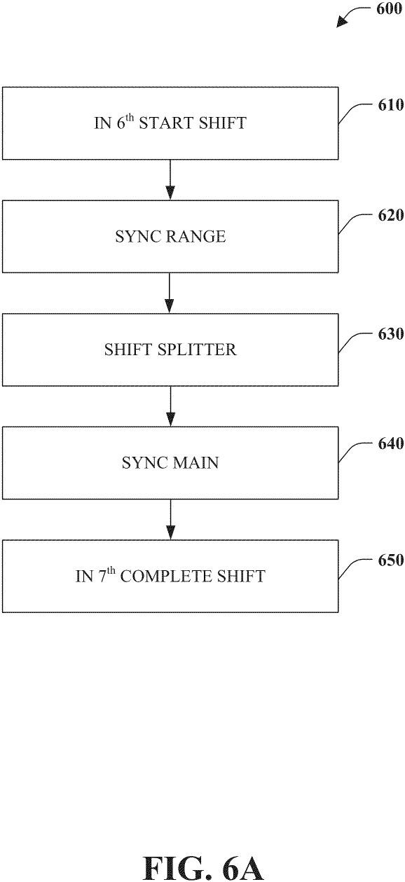

Turning to FIGS. 4 and 5, an innovative process change is exemplified that provides for the ability to reduce parts and system complexity. FIG. 4 portrays a control state diagram 400 of an example gear shift from a 6^{th} gear to a 7^{th} gear. It is to be understood, that the description merely provides an example for comparison to an embodiment of the disclosed innovation. It is to be appreciated that gear changes of both gear shifts up from other gears (i.e., upshift), as well as gear shifts down from one or more gears are amenable to aspects of the innovation, and that a Person Having Ordinary Skill In The Art can readily understand and apply the disclosed innovation in such additional examples.

At 410, a gear shift is started or initiated. At this point, a gear is engaged, for example gear 6. As an engine begins to ramp down torque, one or more main clutches is in a ramp down torque mode. In a splitter group, for example, splitter group 205, as shown in FIG. 2, a splitter synchronizer is engaged. An inertia brake is off. A main box jaw clutch is engaged, and a range synchronizer is engaged.

At 420, the shift is in process, and the engine speed control is at target, while the main clutch is open. The main box jaw clutch is disengaged. The splitter synchronizer, inertia brake and range synchronizer states are not changed.

At 430, the shift is in process as the splitter synchronizer is disengaged, the main box jaw clutch is in a neutral state, and the range synchronizer is disengaged. The status of the engine, main clutch, and inertia brake are maintained.

At 440, the shift is in process as the splitter synchronizer and the range synchronizer each sync. The status of the engine, main clutch, inertia brake, and main box jaw clutch are maintained.

At 450, the shift is in process as the splitter synchronizer engages. The status of the engine, main clutch, inertia brake, main box jaw clutch, and range synchronizer are maintained.

At 460, the shift is in process as the splitter synchronizer stays engaged, and the inertia brake status becomes on sync main. The status of the engine, main clutch, inertia brake, and main box jaw clutch are maintained.

At 470, the shift is in process as the range synchronizer engages. The status of the engine, main clutch, splitter synchronizer, inertia brake, and main box jaw clutch are maintained.

At 480, the shift is in process as the inertia brake is off, and the main box jaw clutch engages. The status of the engine, main clutch, splitter synchronizer, and inertia brake are maintained.

At 490, the shift finalizes for example, at gear 7 as the engine ramps up torque, the main clutch ramps up torque, the inertia brake remains off, and the splitter synchronizer, main box jaw clutch and range synchronizer each stay engaged.

In comparison, as seen in FIG. 5, an embodiment of a control state diagram 500 for an example shift sequence is provided. It is to be appreciated that the complicated range synchronizer has been replaced with a simplified range jaw clutch. In order to accommodate this advantage — without adding a new component, such as for example, a motor driver, for example modifying a configuration by replacing a splitter synchronizer with a splitter jaw clutch — an advance may be realized by configuring a control sequence differently, thereby enabling a reduction in complexity, without the addition of a separate component. In an embodiment, an example shift sequence of a control state diagram 500 reflects a gear shift from one gear to another chosen gear (in this example described in detail herein, gear 6 is shifted to gear 7).

In accordance with the innovation, at 505, a gear shift is started or initiated. At this point, a gear is engaged, for example, gear 6. As an engine begins to ramp down torque, a main clutch is in a ramp down torque mode. In a splitter group, for example 340 as shown in FIG. 3, a splitter synchronizer is engaged. An inertia brake is off. A main box jaw clutch is engaged, and a range jaw clutch is engaged. It is to be understood and appreciated that the range jaw clutch can be a simplified range jaw clutch.

At 515, the shift is in process, and the engine speed control is to target, while the main clutch is open. Here in contrast, the main box jaw clutch remains engaged. The inertia brake is not changed. The range jaw clutch disengages.

At 525, the shift is in process as the described elements continue their status as at 515, with the exception that the inertia brake is brought to an on sync range, and the range jaw clutch is in neutral.

At 535, the shift is in process as the described elements continue their status as at 515, with the exception that the inertia brake stops its “on sync range,” returning to an off status, and the range jaw clutch is also brought to be engaged. It is to be appreciated that this sequence introduces different control actuation, in particular, prior to a splitter synchronizer disengagement, the inertia brake and the range jaw clutch are used to effect an action typically contemplated by a range synchronizer which typically would occur at the same time as the splitter synchronizer.

At 545, the shift is in process as the engine speed control is to target, while the main clutch is open. Further, the inertia brake remains off, a main box jaw clutch and the range jaw clutch remain engaged, and the splitter synchronizer is disengaged.

At 555, the shift is in process as the described elements continue their status as at 545, with the exception that the splitter synchronizer moves to sync.

At 565, the shift is in process as the described elements continue their status as at 545, with the exception that the splitter synchronizer moves to engage.

At 575, the shift is in process as the engine speed control is to target, while the main clutch is open. The splitter synchronizer remains engaged, the inertia brake remains off, and while the range jaw clutch remain engaged, the main box jaw clutch disengages.

At 585, the shift is in process, as the engine is in a mode of speed match, while the main clutch turns from a mode of open to a mode of sync main, and the main box jaw clutch is at neutral. Each of the splitter synchronizer, inertia brake, and range jaw clutch continue their status as at 575.

At 595, the shift is in process as the engine speed match continues, and the main clutch is at slip condition, and the main box jaw clutch engages. Each of the splitter synchronizer, inertia brake, and range jaw clutch continue their status as at 575.

At 599, the shift finalizes for example, at gear 7 as the engine ramps up torque, the main clutch ramps up torque, the inertia brake remains off, and the splitter synchronizer, main box jaw clutch and range jaw clutch each stay engaged.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished following either a push and/or pull control model. The components may also interact with one or more other components not specifically described herein for the sake of brevity but known by those of skill in the art.

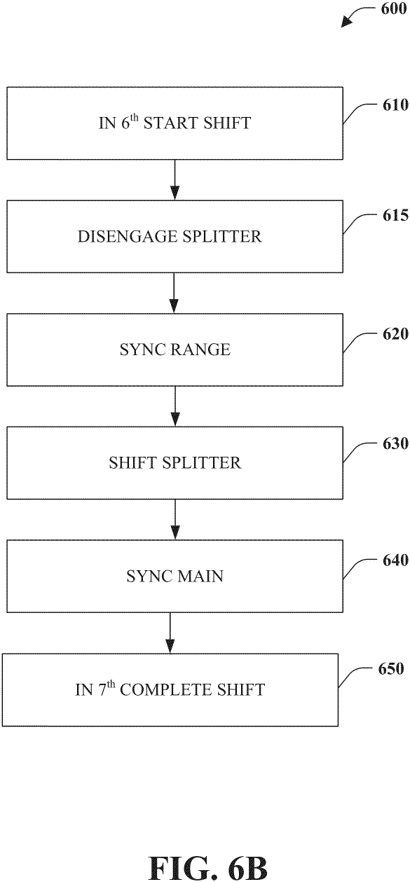

In view of the example systems described above, methods that may be implemented in accordance with the disclosed subject matter will be better appreciated with reference to a flow chart diagram of example methods of shift management as shown in FIGS. 6A-B. While for purposes of simplicity of explanation, methods may be shown and described as a series of blocks, it is to be understood and appreciated that the disclosed subject matter is not limited by order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

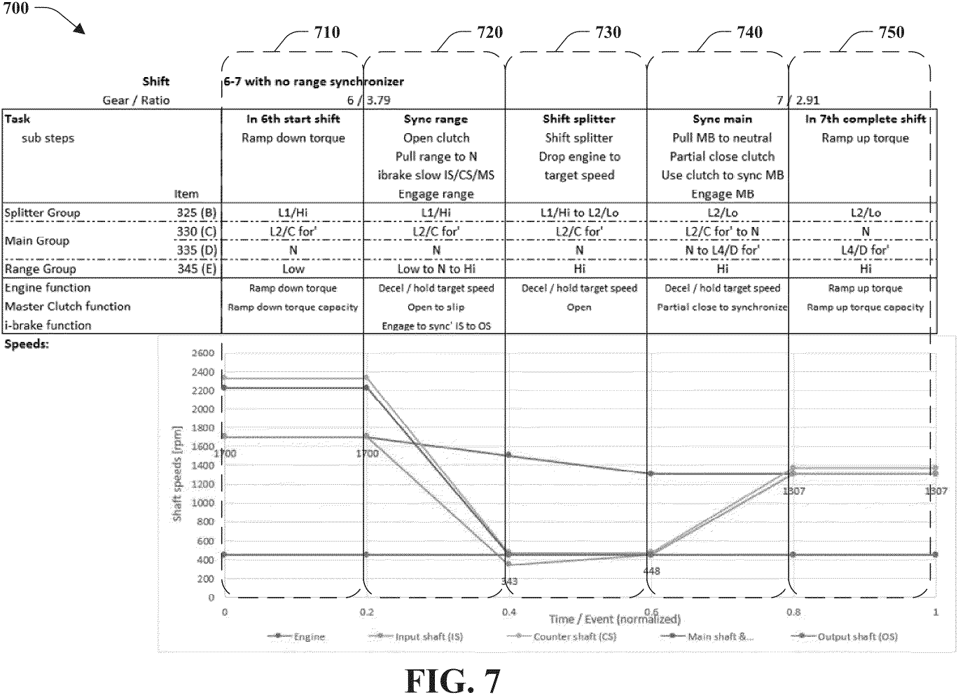

Turning now to FIG. 6A, aspects of the innovation are disclosed in the form of a method flow chart for method 600. The acts of the flow chart of FIG. 6A are also reflected in FIG. 7, which provides a combination flow chart diagram, control state diagram and example speed versus normalized time chart 700. It is to be appreciated that details and descriptions explicating the acts are an example, and other embodiments may become evident upon a review of this specification. Therefore, a Person Having Ordinary Skill In The Art may readily understand and apply the disclosed innovation in other additional examples, for example, FIG. 6B that provides an alternative method flow chart.

In FIG. 6A, method 600 starts at 610, being in 6^{th} gear. It is to be appreciated that this is merely an example, and other examples could commence at a different gear, e.g., include being in 1^{st} or other gears. At 620, the method engages in a sync range. At 630, the method employs a shift splitter. At 640, the method engages a sync main. At 650, the method provides that a shift has been completed - in this example, the shift into 7^{th} gear has been completed.

In the example of FIG. 6B, method 600 starts at 610, being in 6^{th} gear. As mentioned previously, it is to be appreciated that this is merely an example, and other examples could include being in 1^{st} or other gears. At 615, the method disengages the splitter. At 620, the method engages in a sync range. At 630, the method employs a shift splitter. At 640, the method engages a sync main. At 650, the method provides that a shift has been completed - in this example, the shift into 7^{th} gear has been completed.

Turning to FIG. 7, the respective acts 610, 620, 630, 640, and 650 are reflected in the combination state diagram in demarcated areas of 710, 720, 730, 740 and 750 respectively. At 710, the method starts in 6^{th} gear. A sub act is to ramp down torque. In the splitter group, item 325 is at L1 (hi). In the main group, item 330 is at L2/C while item 335 is at neutral (N). In the range group, item 345 is at low. The engine function is ramping down torque, while the master clutch function is ramping down torque capacity. Example speeds of various components are as pictured at 710.

At 720, range sync is the task. Sub acts can include opening the main clutch, pulling range to neutral, using an i-brake to slow input shaft, counter shaft and main shaft, and to engage the range. Items 325, 330 and 335 remain at their previous condition, while item 345 moves from low to neutral or high. The engine function decelerates to a hold at target speed. The master clutch opens to slip and the i-brake functions to engage syncing input shaft to output shaft speeds. Example speeds of various components are as pictured at 720.

At 730, the task of shift splitter is engaged. Sub acts can include engaging the splitter group shift and dropping the engine to target speed. In the splitter group, item 325 moves to L2 or low, and item 345 is at high. The engine function is still decelerating/holding at target speed, and the master clutch function is open. Example speeds of various components are as pictured at 730.

At 740, the task is to synchronize the main group. Sub acts can include pulling a master brake to neutral, partially closing a clutch, and using the clutch to synchronize the main group (main box), and then engaging a master brake. In the splitter group, item 325 remains at L2 (low), while in the main group, item 330 shifts to neutral and item 335 shifts to L4/D. Item 345 in the range group remains at high. The engine function remains at decelerating/holding at target speed, and the master clutch function is partially closed to provide synchronization. Example speeds of various components are as pictured at 740.

At 750, the task of completing the shift into 7^{th} gear is undertaken. Sub acts can include ramping up torque, which is completed by the engine function, while the master clutch function ramps up torque capacity. Example speeds of various components are as pictured at 750.

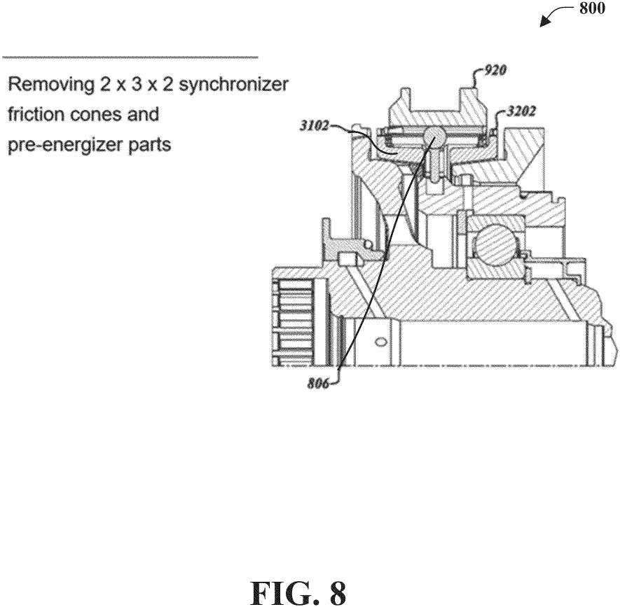

Turning to FIG. 8, a portion 800 of a range group is shown upon which component simplification can occur in accordance with the subject disclosure. As shown, synchronizer friction cones and pre-energizer parts such as for example 3102, 3202 and 806 are shown, and would be configurations related to a range synchronizer as may be a part of the range group 215 as shown in FIG. 2. It is to be appreciated that as shown in a range group 315, as may be seen in FIG. 3, a simplified range jaw clutch (e.g., without inducing the need for any other components such as a motor generator) could be configured, eliminating such components and it is to be further appreciated, that this simplification is provided by way of the change in control sequence for the shift control as discussed in relation to FIGS. 5-7. It should be noted that the configurations of gear positions described as L1/Hi, L2/Lo may apply to an overdrive transmission, but can be re-arranged for other ratios such as a direct drive transmission (e.g., top gear ratio 1:1). In a direct drive transmission it is common for gear positions to be re-arranged to L1/Lo and L2/Hi.

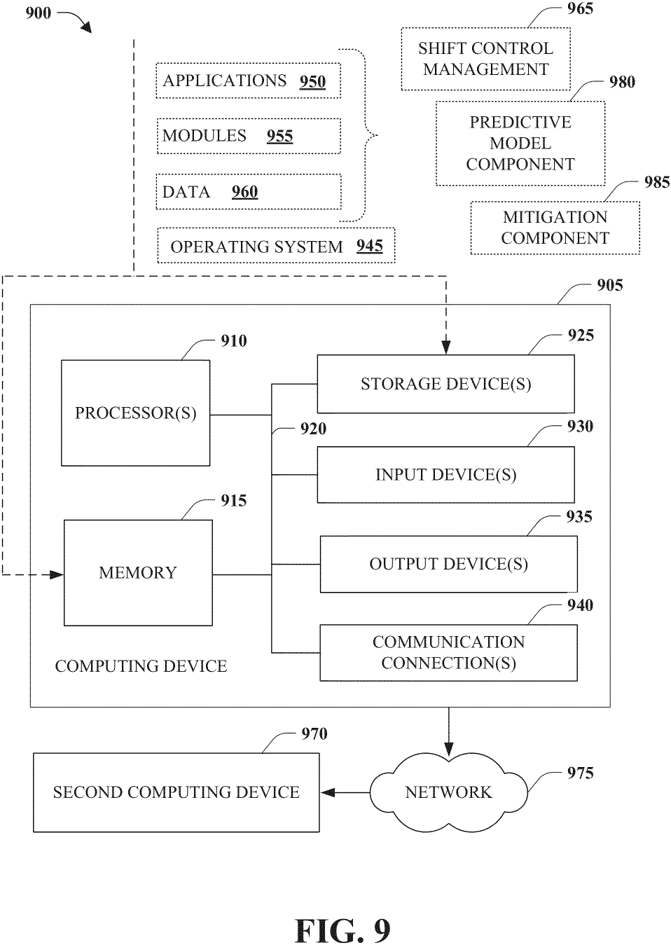

To provide a context for the disclosed subject matter and in particular to the computer (e.g., controller) aspects, FIG. 9, as well as the following discussion, is intended to provide a brief, general description of a suitable environment in which various aspects of the disclosed subject matter can be implemented. However, the suitable environment is solely an example and is not intended to suggest any limitation regarding scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch...), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules may be located in one or both of local and remote memory devices.

With reference to FIG. 9, illustrated is an example computing device 905 (e.g., desktop, laptop, tablet, watch, server, hand-held, programmable consumer or industrial electronics, set-top box, game system, compute node, and the like). The computing device 905 includes one or more processor(s) 910, memory 915, system bus 920, storage device(s) 925, input device(s) 930, output device(s) 935, and communications connection(s) 940. The system bus 920 communicatively couples at least the above system constituents. However, the computing device 905, in its simplest form, can include one or more processors 910 coupled to memory 915, wherein the one or more processors 910 execute various computer-executable actions, instructions, and or components stored in the memory 915.

The processor(s) 910 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 910 may also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 910 can be a graphics processor unit (GPU) that performs calculations concerning digital image processing and computer graphics.

The computing device 905 can include or otherwise interact with a variety of computer-readable media to facilitate control of the computing device to implement one or more aspects of the disclosed subject matter. The computer-readable media can be any available media accessible to the computing device 905 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM), magnetic storage devices (e.g., hard disk, floppy disk, cassettes, tape...), optical disks (e.g., compact disk (CD), digital versatile disk (DVD), and solid-state devices (e.g., solid-state drive (SSD), flash memory drive (e.g., card, stick, key drive...), or any other like mediums that store, as opposed to transmit or communicate, the desired information accessible by the computing device 905. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 915 and storage device(s) 925 are examples of computer-readable storage media. Depending on the configuration and type of computing device, the memory 915 may be volatile (e.g., random access memory (RAM)), non-volatile (e.g., read only memory (ROM), flash memory...), or some combination of the two. By way of example, the basic input/output system (BIOS), including basic routines to transfer information between elements within the computing device 905, such as during start-up, can be stored in non-volatile memory, while volatile memory can act as external cache memory to facilitate processing by the processor(s) 910, among other things.

The storage device(s) 925 include removable/non-removable, volatile/non-volatile storage media for storage of vast amounts of data relative to the memory 915. For example, storage device(s) 925 include, but are not limited to, one or more devices such as a magnetic or optical disk drive, floppy disk drive, flash memory, solid-state drive, or memory stick.

Memory 915 and storage device(s) 925 can include, or have stored therein, operating system 945, one or more applications 950, one or more program modules 955, and data 960. The operating system 945 acts to control and allocate resources of the computing device 905. Applications 950 include one or both of system and application software and can exploit management of resources by the operating system 945 through program modules 955 and data 960 stored in the memory 915 and/or storage device(s) 925 to perform one or more actions. Accordingly, applications 950 can turn a computing device into a specialized machine in accordance with the logic provided thereby. In other words, it is to be appreciated that configuring general computing components to carry out an ordered specific sequence may be construed as a special purpose machine.

All or portions of the disclosed subject matter can be implemented using standard programming and/or engineering techniques to produce software, firmware, hardware, or any combination thereof to control the computing device 905 to realize the disclosed functionality. By way of example and not limitation, all or portions of the shift management system 965 can be, or form part of, the application 950, and include one or more modules 955 and data 960 stored in memory and/or storage device(s) 925 whose functionality can be realized when executed by one or more processor(s) 910.

In accordance with one particular embodiment, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 915, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the shift management system 965 and/or functionality associated therewith can be embedded within hardware in a SOC architecture.

The input device(s) 930 and output device(s) 935 can be communicatively coupled to the computing device 905. By way of example, the input device(s) 930 can include a pointing device (e.g., mouse, trackball, stylus, pen, touchpad ...), keyboard, joystick, microphone, voice user interface system, camera, motion sensor, and a global positioning satellite (GPS) receiver and transmitter, among other things. The output device(s) 935, by way of example, can correspond to a display device (e.g., liquid crystal display (LCD), light emitting diode (LED), plasma, organic light-emitting diode display (OLED)...), speakers, voice user interface system, printer, and vibration motor, among other things. The input device(s) 930 and output device(s) 935 can be connected to the computing device 905 by way of wired connection (e.g., bus), wireless connection (e.g., Wi-Fi, Bluetooth ...), or a combination thereof.

The computing device 905 can also include communication connection(s) 940 to enable communication with at least a second computing device 970 utilizing a network 975. The communication connection(s) 940 can include wired or wireless communication mechanisms to support network communication. The network 975 can correspond to a local area network (LAN) or a wide area network (WAN) such as the Internet. The second computing device 970 can be another processor-based device with which the computing device 905 can interact. In one instance, the computing device 905 can perform operations associated with the shift management system 965, and the second computing device 970 can correspond to one or more servers or other systems that provide network-accessible services for use by the shift management system 965. For example, the second computing device 970 can supply valuable driving data for use by the shift management system 965 in remote shift management.

Various portions of the disclosed systems and methods above can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers, and the like). Such components, among others, can automate certain mechanisms or processes performed thereby, making portions of the systems and methods more adaptive as well as efficient and intelligent. By way of example, and not limitation, the predictive model component 980 of the shift management system 965 can employ such mechanisms to predict or otherwise infer shift changes based on changing conditions. Additionally, the mitigation component 985 can use such mechanisms to infer and suggest a mitigation strategy.

As used herein, the terms “component” and “system,” as well as various forms thereof (e.g., components, systems, sub-systems...) are intended to refer to a computer-related entity, either hardware, a combination of hardware and software, software, or software in execution. For example, a component may be but is not limited to being a process running on a processor, a processor, an object, an instance, an executable, a thread of execution, a program, and/or a computer. By way of illustration, both an application running on a computer and the computer can be a component. One or more components may reside within a process and/or thread of execution, and a component may be localized on one computer and/or distributed between two or more computers.

As used herein, the term “infer” or “inference” generally refer to the process of reasoning about or inferring states of a system, a component, an environment, or a user from one or more observations captured by way of events or data, among other things. Inference may be employed to identify a context or an action or may be used to generate a probability distribution over states, for example. An inference may be probabilistic. For example, computation of a probability distribution over states of interest can be based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several events and data sources.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What has been described above includes examples of aspects of the claimed subject matter. It is, of course, not possible to describe every conceivable combination of components or methodologies for purposes of describing the claimed subject matter. However, one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system for a gear change, comprising:
a splitter group that includes a splitter synchronizer;
a main group that includes a first main jaw clutch and a second main jaw clutch;
a range group that includes a range jaw clutch;
wherein the splitter group, main group, and range group engage a ramping down torque task;
wherein the range group engages a range sync task;
wherein the splitter group and range group engage a shift splitter task;
wherein the splitter group and the main group engage a main group synchronizing task; and
wherein the main group engages a gear change completion task.

2. The system of claim 1, wherein the ramping down torque task comprises:
an engine function that ramps down torque, while a master clutch function ramps down torque capacity.

3. The system of claim 2, further:
in the splitter group, the splitter synchronizer is at L1 (hi);
in the main group, the first main jaw clutch is at L2/C, while the second main jaw clutch is at neutral (N); and
in the range group, the range jaw clutch is at low.

4. The system of claim 1, wherein the range sync task comprises:
a master clutch that opens;
a range that pulls to neutral, wherein the range optionally pulls the splitter to neutral;
an i-brake that slows an input shaft, a counter shaft and a main shaft, and to engage the range;
the range jaw clutch that moves from low to neutral or high, while the splitter synchronizer is at L1(hi), the main jaw clutch is at L2/C, and the second main jaw clutch is at neutral (N); and
an engine function that decelerates to a hold at a target speed;
wherein the master clutch and the i-brake engage to sync a speed of the input shaft to a speed of an output shaft.

5. The system of claim 1, wherein the shift splitter task comprises:
the splitter group and the range group that engages to drop an engine to a target speed,
wherein in the splitter group, the splitter synchronizer transitions from L1(hi) to L2 (low), and wherein in the range group, the range jaw clutch transitions to high, while an engine function decelerates or holds at the target speed, and a master clutch function is open.

6. The system of claim 1, wherein the main group synchronizing task comprises:
a master brake that pulls to neutral;
a clutch that partially closes thereby synchronizing the main group; and
a master brake that engages.

7. The main group synchronizing task of claim 6, wherein:
in the splitter group, the splitter synchronizer remains at L2 (low), while in the main group, the first main jaw clutch shifts to neutral and the second main jaw clutch shifts to L4/D;
in the range group, the range jaw clutch remains at high; and
an engine function remains at decelerating/holding at a target speed, and a master clutch function is partially closed.

8. The system of claim 1, wherein the gear change completion task comprises:
an engine function that ramps up torque; and
a master clutch function that ramps up torque capacity.

9. An upshift method for a gear shift, comprising:
a first act of:
preparing for the upshift by:
ramping down torque, by an engine, and
ramping down torque mode, by a main clutch;
engaging a splitter synchronizer, in a splitter group;
turning off an inertia brake;
engaging a main box jaw clutch;
engaging a range jaw clutch;
a second act of disengaging the range jaw clutch;
a third act of bringing to an open sync range, by the inertia brake, and placing the range jaw clutch in neutral;
a fourth act of stopping its “on sync range”, and returning to an off status, by the inertia brake, and engaging the range jaw clutch;
a fifth act of disengaging the splitter synchronizer as an engine speed control is to target, the main clutch is open the inertia brake remains off, the main box jaw clutch and the range jaw clutch remain engaged;
a sixth act of moving to sync, by the splitter synchronizer;
a seventh act of moving to engage, by the splitter synchronizer;
an eighth act of disengaging the main box jaw clutch;
a ninth act of:
while each of the splitter synchronizer, the inertia brake, and the range jaw clutch continue their respective status:
putting the engine in a mode of speed match,
turning from a mode of open to a mode of sync main, by the main clutch, and
placing the main box jaw clutch at neutral;
a tenth act of placing the main clutch at a slip condition, and engaging the main box jaw clutch; and
an eleventh act of engaging a next gear by:
finalizing the gear shift,
ramping up an engine torque, and
ramping up a torque on the main clutch.

10. The upshift method of claim 9, wherein for the second act, the engine speed control is to the target, and while the main clutch is open, the main box jaw clutch remains engaged, the inertia brake is unchanged.

11. The upshift method of claim 9, wherein the fourth act comprises:
prior to the splitter synchronizer disengagement, the inertia brake and the range jaw clutch are used to effect an action typically contemplated by a range synchronizer, which typically would occur at the same time as the splitter synchronizer.

12. The upshift method of claim 9, wherein for the eighth act of disengaging the main box jaw clutch:
the engine speed control is to the target, the main clutch is open, the splitter synchronizer remains engaged, the inertia brake remains off, and the range jaw clutch remain engaged.

13. The upshift method of claim 9, wherein for the tenth act:
each of an engine speed, the splitter synchronizer, the inertia brake, and the range jaw clutch continue their respective status.

14. The upshift method of claim 9, wherein for the eleventh act:
while the inertia brake remains off, the splitter synchronizer, the main box jaw clutch and the range jaw clutch each stay engaged.

15. A system for a gear change, comprising:
a splitter group that includes a splitter synchronizer;
a main group that includes a first main jaw clutch and a second main jaw clutch;
a range group that includes a range jaw clutch; and
a processor coupled to a memory that includes instructions that, when executed by the processor, cause the processor to engage in a controlled manner to control a ramping down torque task, a range sync engaging task, a shift splitter engaging task, a main group synchronizing task, and a gear change completion task.

16. The system of claim 15, wherein the ramping down torque task comprises:
an engine function that ramps down torque while a master clutch function ramps down torque capacity, while in the splitter group, the splitter synchronizer is at L1 (hi), in the main group, the first main jaw clutch is at L2/C while the second main jaw clutch is at neutral (N), and in the range group, the range jaw clutch is at low.

17. The system of claim 15, wherein the range sync engaging task comprises:
a master clutch that opens;
a range that pulls to neutral;
an i-brake that slows an input shaft, a counter shaft and a main shaft, and to engage the range;
wherein the range jaw clutch moves from low to neutral or high, while the splitter synchronizer is at L1 (hi), the first main jaw clutch is at L2/C, and the second main jaw clutch is at neutral (N);
an engine function that decelerates to a hold at a target speed; and
wherein the master clutch and the i-brake engage to sync a speed of the input shaft to a speed of an output shaft.

18. The system of claim 15, wherein the shift splitter task comprises:
the splitter group and the range group that engages to drop an engine to a target speed,
wherein in the splitter group, the splitter synchronizer transitions from L1 (hi) to L2 (low), and wherein in the range group, the range jaw clutch transitions to high, while an engine function decelerates or holds at target speed, and a master clutch function is open.

19. The system of claim 15, wherein the main group synchronizing task comprises:
a master brake that pulls to neutral;
a clutch that partially closes thereby synchronizing the main group;
a master brake that engages; and wherein:
in the splitter group, the splitter synchronizer remains at L2 (low), while in the main group, the first main jaw clutch shifts to neutral and the second main jaw clutch shifts to L4/D;
in the range group, the range jaw clutch remains at high; and
an engine function remains at decelerating/holding at a target speed, and a master clutch function is partially closed.

20. The system of claim 15, wherein gear change completion task comprises:
an engine function that ramps up torque; and
a master clutch function that ramps up torque capacity.
